(19) United States
(12) Patent Application Publication
(10) Pub. No.: US 2009/0011954 A1
(43) Pub. Date: Jan. 8, 2009

(54) Thin Sheet for Retaining Biomolecules

(75) Inventors: Barry Beroth, Tucson, AZ (US); Alan Gordon Goodyear, Tucson, AZ (US)

Correspondence Address: LAWRENCE R. OREMLAND, P.C., 5055 E. BROADWAY BLVD., SUITE C-214, TUCSON, AZ, 85711, US

(73) Assignee: 3dbiosurfaces Technologies, L.L.C, Tucson, AZ (US)

(21) Appl. No.: 12/281,755

(22) PCT Filed: Mar. 7, 2007
(86) PCT No.: PCT/US07/05731

§ 371 Date: Sep. 4, 2008

Related U.S. Application Data
(60) Provisional application No. 60/779,972, filed on Mar. 8, 2006.

(51) Int. Cl. C40B 40/00

(52) U.S. Cl. 506/13

(57) ABSTRACT

This invention has application in a variety of biological and biochemical fields. The invention describes a thin sheet or sheets of flexible material with surface characteristics that provide an environment for retaining biological molecules. The flexible nature of the thin sheet of material permits the use of continuous preparation, processing and analysis techniques involving more compact and less complex equipment. The invention also describes a lamination of a thin sheet of flexible material to a substantially rigid second substrate so that the combination can be processed by existing equipment. The thin sheet of flexible material may be perforated prior to lamination in order to establish distinct wells in the surface of the lamination.

### RELATED APPLICATION

This application is related to and claims priority from U.S. provisional application entitled “Flexible sheet for retaining biomolecules”, Ser. No. 60/779,972, filed Mar. 8, 2006, which provisional application is incorporated by herein by reference in its entirety.

### TECHNICAL FIELD

This invention has application in a variety of biological and biochemical fields. The invention describes a thin sheet or sheets of flexible material with surface characteristics that provide an environment for retaining biological molecules. The flexible nature of the thin sheet of material permits the use of continuous preparation, processing and analysis techniques involving more compact and less complex equipment. The invention also describes a lamination of a thin sheet of flexible material to a substantially rigid second substrate so that the combination can be processed by existing equipment. The thin sheet of flexible material may be perforated prior to lamination in order to establish distinct wells in the surface of the lamination.

### BACKGROUND OF THE INVENTION

Developments in various branches of biology and biochemistry have led to increased use of substrates that anchor biological molecules for the purpose of interaction with other biomolecules and subsequent analysis and identification. These substrates permit large number of experiments to be performed in parallel. The biomolecules are located in discrete and separate locations (usually referred to as spots) on the substrate. These substrates exist in a variety of formats; the most common of these, the microarray, is based on the laboratory microscope slide.

Traditionally, the microarray substrate is comprised of a rigid support made of planar glass or rigid plastic that is modified or coated in a way to allow the desired binding of biomolecules to the surface of the support. Representative prior art disclosing rigid, solid support includes U.S. Pat. No. 5,445,934 and U.S. Pat. No. 5,744,305 to Fodor et al. which teach methods of synthesizing oligonucleotides in an array format onto a planar, non-porous solid support. U.S. Pat. No. 6,372,813 teaches a method of coating a rigid substrate with a polymer network layer that comprises a series of interconnected cavities or pores into which the biomolecules can diffuse prior to attachment. This layer is attached to the surface of the substrate and the combination of the substrate and the layer is required for successful use.

The rigid property of the substrates has limited the possible ways in which biomolecules are introduced to the surface and restricts methods of processing and analysis. Printing or assembling biomolecules in a dense (i.e. closely packed) pattern on a surface requires the extensive use of x-y-z mechanisms that move across the rigid surface. Considerable precision is required and this necessitates complex machines to achieve the placement. The scanning of the rigid substrate after the interaction requires a similar mechanical capability.

In US Patent Application 20020182629, Rich teaches a flexible material coated with a linker material that is used as a substrate for microarray purposes. Rich defines flexible substrates, “as being those which do not break or craze or become permanently deformed when bent through a plane of at least 15 degrees from planar.”

The invention in U.S. Patent Application 2002/0098124 to Bentsen et al. provides polymeric articles useful for processing microfluid samples that can be continuously molded in two parts (e.g., a molded article with a chamber for fluids to be deposited into and a cover) pressed together and formed into a roll. The use of high-volume, web-processing for surface modification is not described and not obvious for a covered microfluidic device. The roll can be used directly for processing a fluid sample in a reel-to-reel continuous process involving injecting a different fluid into each microfluid processing architecture and then performing multiple operations.

Schembri, in U.S. Patent Application (2004/0087008) and a series of related U.S. Patent Applications (2004/0087009, 2004/0086869, 2004/0086871 and 2004/0086424), describes a composite flexible array substrate comprising, in order, a flexible support, a flexible base, a reflective layer, and a transparent layer. Schembri primarily teaches the use of this substrate as a microfluidics device.

Schembri defines a material, structure, or device as flexible if it can be flexed from an essentially flat configuration into a substantially cylindrical shape and then unrolled to lay flat without cracking, breaking, or substantially altering the ability of the material to function for its intended use. Substantial in this regard means that the intended function is altered by less than 20%, or typically less than 10%, or more typically less than 5%, of the function as measured between a material that has been subjected to the above test of five repeated rollings and unrollings versus material that has not been so-tested. In the particular case of a flexible array, the intended function may be the ability to give a clearly determinable signal of binding of a target molecule at a particular feature when the array is used as intended.

In U.S. Pat. No. 6,841,663, co-owned with Schembri's applications described above, Lefkowitz, Perbost, Kanemoto and Schembri, teach methods for driving, in a lengthwise direction, a flexible elongated web through a series of applications stations. These application stations (e.g., a series of baths) can include operations for preparing the surface of the substrate, depositing biological materials, adding certain chemicals (e.g., reagents), washing, drying and inspections. The use of baths to modify the surface of the substrate differs from the high-volume, web-based processing described later on in this invention.

The current art does not define a thin sheet of flexible material. A thin sheet of is made of a material that can be bent but returns substantially to its original form when released from its bent form. Some external force may be required to assist in this process. It is recognized that some time may pass before the substrate returns completely to its original form. It is also recognized that a fold or crease cannot be reversed. The thin sheet of flexible material has sufficient mechanical properties to exist as a separate entity. The thin sheet must be sufficiently thin and mechanically strong enough so it can be coated and processed using high-speed, web-processing, printing, or other equipment. The sheet must be capable of further processing on a stand-alone basis, or being laminated onto a rigid surface and cut into dimensions suitable for use in current equipment. Flatness is required for use with current equipment. Flatness is defined as a variation in thickness of less than 10%, and preferably less than 5%.

The use of a thin sheet offers many advantages. Thin films can be processed on high-speed webs with ultra-thin, highly consistent coatings (e.g., surface modification) applied. Coatings can be applied using a variety of methods (such as, but not limited to, sputtered coatings, vapor deposition, chemical vapor deposition, physical vapor deposition, cathodic arc, thermal evaporation, electron beam, and plasma) in either atmospheric or vacuum environments. This can be done on a continuous or batch basis. Additional processing such as depositing biomolecules, reagent chemicals, etc. can take place using these same processes or using other processes (e.g., such as described by Lefkowitz below) that also benefit from the flexibility of a thin film over rigid surfaces.

The current art does not provide for the use of high-speed, web-based processing to modify the surface of a thin sheet to retain biomolecules by itself or attached to a rigid surface for further processing and analysis (using the high-speed web or other means). This invention describes a thin sheet capable of being processed using high-volume, web-based processing.

None of the current art teaches the use of flexible arrays in current equipment configurations. This invention describes a laminated thin sheet structure capable of fitting into current equipment configurations.

The current art does not teach the use of laminates wherein one layer of the laminates comprises a series of perforations that when laminated to a second substrate layer results in a plurality of well-like structures on one surface of the combination. These wells can be arrayed to resemble a multiwell plate. The properties of the second substrate can be altered to receive and retain biomolecules.

### BRIEF SUMMARY OF THE INVENTION

Throughout this invention the term “thin sheet of flexible material” shall be understood to incorporate a single sheet of such material, or a plurality of single sheets of materials with differing properties that are sandwiched together to form a laminate construction. The laminate construction may be rigid.

The present invention discloses novel uses of a thin sheet of flexible material with a surface in which biomolecules can be received and retained. The thin sheet of flexible material can be used to retain a variety of biomolecules on or in the surface of the sheet at known locations. This process is referred to as “printing an array”. The thin sheet or web of flexible material can retain the biomolecules by either physical or chemical means. Such methods of capture are well known to practioners of the art. The thin sheet of flexible material and its complement of biomolecules can be then be introduced to other molecules, including other biomolecules, and then subjected to some form of analysis by methods that are widely known. The flexible nature of the sheet or web permits a variety of simpler and more compact printing and analysis methods.

The invention comprises a thin sheet of flexible material (or materials since the sheet may comprise a laminate of sheets) with surfaces with particular characteristics suited for attachment or retention of biomolecules. The thin sheet of flexible material has sufficient mechanical properties to exist as a separate entity. Biomolecules are attached to the surface directly or via intermediate coatings of other materials. The biomolecules are deposited at discrete and separable sites on the surface

The printed thin sheet of flexible material may now be processed by a one of a variety of well-established protocols in which other molecules, including other biomolecules, are introduced to the retained biomolecules for the purpose of identifying the nature of the molecules. After the passage of time, thin sheet of flexible material is subjected to further processing that includes washing, drying and inspection processes.

The thin sheet of flexible material may have various surface features configured to increase the capacity of a surface to retain biological molecules. One preferred embodiment involves increasing the topological surface area. Another embodiment involves altering the surface properties such that biomolecules are retained only in certain locations.

The thin sheet of material may comprise more than one layer of one or different materials to form a laminate. Each of the thin sheets of material within a laminate of flexible material may have distinct and useful properties including but not limited to surface features that increase the topographical area of the surface, various optical properties such as reflection, absorption or emission of electromagnetic radiation, electrical properties that include conduction of signals generated in other layers of the laminate.

One embodiment of the invention involves a thin sheet of flexible material with sufficient mechanical integrity to exist independently that can be temporarily attached to another substrate that can be either a flexible sheet (with similar or different properties), a relatively rigid sheet or even a relatively rigid frame. This second substrate can be viewed a means of transport, storage or even as a conveyor belt for moving the thin flexible sheet through its processing stages.

The invention further describes the attachment of all or part of the treated thin sheet of flexible material to a rigid, impermeable substrate. A variety of methods of attachment are possible; the use of adhesives is the simplest but other are also beneficial. Mechanical clamping or fusing are also alternatives. Once attached to the second surface, analysis and identification techniques can be used on the laminate. This embodiment would allow the use of the flexible sheet with conventional printing and processing equipment. A substantially flat substrate will be one preferred embodiment but a curved substrate such as a cylinder may also be preferred.

The thin sheet of flexible material defined by this invention will have a lower cost but, more importantly, will allow the use of less complex, lower cost devices for the preparation, processing and analysis of the materials captured on the thin sheet. The flexible nature of the substrate will allow processing through more compact and traditional printing methods (e.g. embossing, ink-jet) or electrostatic attachment (i.e. laser printers). Processing may continue to be discrete but it is more likely that it will be achieved using sequentially, continuous stages (reminiscent of the current generation of store-based photo processing equipment). The detection stage will also be much simplified and simple scanning devices will be available for use. The overall result will be that the use of biomarkers and microarray methods will allow faster, lower cost analysis. The complete process will be more suited to a hospital, physician's office or a clinic. As microarrays become diagnostic tools, much smaller number of sites (perhaps about 1000 or less) will only be required. This will permit the use of larger spots and result in easier detection. Biological molecules, called biomarkers, that have been shown to indicate the increased likelihood of a disease or to indicate an increased or reduced interactions with medicines will be anchored to the microarray surface. Interactions between unknown biomolecules from a specific individual, animal or plant and these biomarker molecules will indicate a relative propensity for that individual, animal or plant to contract that specific disease or interact with a specific drug. The diagnostic application of microarray technology will demand a much lower overall cost of processing. The thin sheet of flexible material defined by this invention is the key to this transformation.

### DETAILED DESCRIPTION OF THE INVENTION

### The Present Invention

### A Thin Sheet of Flexible Material

A thin sheet or web of flexible material (FIG. 1) with surfaces configured to retain biomolecules. It is more usual to retain biomolecules to only one surface. This will be referred to as the first surface. The opposing surface will be referred to as the second surface. Generally the thickness of the thin sheet of flexible material is less than the extent of the substrate in the plane of the sheet. The first surface is coated with a pattern of distinct spots of the linker material suitable for the retention of biomolecules. Biomolecules with known properties (i.e. structure) are located at discrete, separate locations (110). Such biomolecules are often called “probes” Each spot of probe biomolecules covers a plurality of the spots of linker material. The spots of linker material act as anchoring points and secure the spot of probe biomolecule. This avoids the registration problem expressed as an issue by practitioners of the art. The thin sheet of material itself can be comprised of material suited for the retention of biomolecules or it can be coated (130) with a different material suited for the retention of biomolecules.

The invention is described in term of a “thin sheet of flexible material”. It is understood that this term includes the concept of a continuous ribbon or web of material. The term also includes the concept of smaller, label-like, fragments of material. In one embodiment of the invention a series of label-like fragments of flexible material are disposed onto another larger sheets of flexible material. The term “thin sheet of flexible material” encompasses the terms “thin sheet”, “flexible material”, “sheet”, label, labels attached to another sheet.

The thin sheet of flexible material is selected to be an inert (and in preferably, a low fluorescence) material. The material comprising the thin sheet may be a metal foil, an organic or inorganic compound, a polymer, a copolymer, a mixture of polymers or a ceramic. Combinations of these materials (as laminates or mixtures) are also incorporated into this invention. The thin sheet may be fully dense, porous or fibrous.

The thin sheet of flexible material may be substantially flexible. Here, flexibility may be defined in terms of a radius of curvature (FIG. 8); when the thin sheet of flexible material is bent such that one face is moved towards contact with the same face at some distant point, the compound surface may be described in terms of a series of arcs with differing radii of curvature. Generally, this results in a curved section of the thin sheet of flexible material that can be characterized by a radius. This radius may have varying values (810, 820, 830, 840 and 850). Typical values can range from 1 meter to 0.001 meters. A rigid substrate generally will also bend but not to any great extent. It will, however, eventually fracture when the applied force exceeds a certain limit. It is important that the material used for the thin sheet of flexible material does not fracture under such treatment nor should it collapse into a fold or a crease. Additionally, it is a requirement that such a bent thin sheet of flexible material return substantially to its original form when released from its bent form. (Some external force may be required to assist in this process). It is recognized that some time may pass before the substrate returns completely to its original form. It is also recognized that a fold or crease cannot be reversed.

The thin sheet of flexible material should have sufficient mechanical integrity that it can be handled without significant degradation, rupture or permanent creasing. The thin sheet should not distort significantly in any direction in the plane associated with upper or lower surface of the thin sheet of flexible material.

The thin sheet of flexible material may have a further variety of surface properties that are conducive to the retention of biomolecules on and in the surface of the thin sheet of flexible material. In a preferred embodiment, areas that are hydrophilic (140) would encourage the preferential retention of an aqueous solution or suspension of biomolecules on those sites. In another embodiment, areas with a hydrophobic nature (150) would surround the areas of hydrophilic nature. This combination would enhance the ease with which biomolecules are retained at the hydrophilic locations. This arrangement could be inverted when dealing with biomolecules that prefer hydrophobic environments.

The thin sheet of flexible material may have a variety of internal structures. Thin sheet of flexible material can be fully dense, porous or fibrous. Thin sheets of a porous material are one preferred embodiment. Biomolecules would be retained inside the pores that can be accessed from either or both surfaces. Generally, the pores would have internal diameters ranging from a few nanometers up to hundreds of microns. Thin sheet of flexible materials that are fibrous are also a preferred embodiment with fiber diameters ranging from 0.1 nm up to 10 microns. Thin sheet of flexible materials of carbon nanotubes are a specific embodiment as are mats of cellulosic fibers. Mats of electrospun fibers would also lie within the scope of this invention.

The substrate will permit the attachment of biomolecules by either physical or chemical means. A preferred embodiment involves chemical attachment (by, for example, covalent bonding) between molecules in the linker sites on the thin sheet of flexible material and the biomolecule. Physical retention also includes entrapment by topological means. Such “cages” act to localize the biomolecule without restricting local movements such as protein folding. Physical attachment includes electrostatic forces between molecules (such as Van de Waals forces). Additionally electrostatic charges embedded in the surfaces are incorporated herein.

The thin sheet of flexible material can have areas upon either or both of its surfaces that have differing chemical or physical properties (140, 150). The spacing between these areas of differing surface properties would be varied in accordance with the size of the droplets of fluid being delivered to the surface of the thin sheet of flexible material. Such surface islands (190) on the surface of the thin sheet of flexible material would be smaller than any spot of liquid (160) being delivered to such surfaces. This careful distinction avoids any requirements to align any means of delivering such drops of fluid (170) with the islands printed on the surface (180).

When viewed along the normal to a surface, the actual area of a smooth surface is identical to the viewed are. When a non-smooth surface is viewed in this way, the actual area is larger than the viewed area. This actual area is often called the topographical area. Area, in this context, is understood to mean the surface available for locating biomolecules on that surface. This is illustrated in FIG. 2.

The thin sheet of flexible material (FIG. 2) may have a number of surface characteristics. Generally, a smooth surface is a viable surface for retention of biomolecules. Significant performance enhancements, however, may be achieved by creating a surface texture on either or both of the surfaces (200). The texture can comprise of several different structures including but not limited to rods (210), wells (220), curves (230) fine hair-like 250). The texture may be uniform or be located at discrete, separate locations. The texture may exhibit a hierarchical nature wherein there are smaller three-dimensional surface features (250) within other larger, three-dimensional surface features (240).

The thin sheet of flexible material (200) could have a variety of three-dimensional surface features (210, 220, 230) designed to increase the available area for attachment of biomolecules. Such surface features create a surface roughness on the surface of the thin sheet. These surface features are especially beneficial when they have an anisotropic, branching nature that involves a large passage dividing into several smaller passage that lead deeper into the body of the substrate. Such surface features are beneficial when small surface features (250) are embedded within other, larger (240) features.

In some embodiments, the surface of the thin sheet of flexible material will contain contiguous features that serve to partition the surface of the substrate into distinct well like (240) structures. These well-like microfeatures are smaller that the spots or microarray elements and serve to both localize drops of liquid delivered to the surface and increase topographical surface area. Internal to each of these microfeatures are other, smaller microfeatures (250) that also provide increased topographical area. Spots of linker material will be disposed within these microfeatures.

The thin sheet of flexible material can be transparent or opaque. If transparent, the preferred embodiments would be completely clear or at least transparent at those wavelengths used for analysis of the retained biomolecules. If opaque, the preferred embodiments would involve colors that minimize reflection or maximize absorption and therefore background signals. A black color is one preferred option.

The thin sheet of flexible material with biological molecules anchored on one surface may also have a mirrored surface on its other surface. Alternatively, the thin sheet of flexible material may have a mirrored surface as its first surface to which linker material is disposed as spots and to which probe biomolecules are subsequently attached. This mirrored surface serves to reflect radiation emitted from moieties retained by the thin sheet of flexible material into the detector.

### A Thin Laminate Sheet of Flexible Material

A thin sheet of material may also comprise several thin sheets of similar or different material (FIG. 3) that are sandwiched together. These will be called thin laminate sheets of material (300). The laminate may be coated with a layer of linker material (320) designed to retain biomolecules. The outer first sheet of the laminate may itself be a material suitable for the retention of biomolecules. In a preferred embodiment, the first surface is coated with a pattern of spots comprising the linker material.

At least one of the sheets of thin flexible material will have surface properties similar to those described for the single thin sheet of flexible material. These include, but are not limited to, discrete and separate locations for the biomolecules (310), surfaces features that enhance or reduce the ability of biomolecules to be retained by the surface (330) and three-dimensional features designed to increase topographical area available for retention of biomolecules (FIG. 4).

The invention is described in term of a “thin laminate sheet of flexible material”. It is understood that this term includes the concept of a continuous ribbon or web of material. The term also includes the concept a smaller, label-like, fragment of material. The term “thin laminate sheet of flexible material” encompasses the terms “thin sheet”, “flexible material”, “sheet

A thin laminate sheet of flexible material is subject to the same description of flexibility as is given in [0035]. Similarly, the thin laminate sheet of flexible material will incorporate the descriptions specified for a single thin sheet of flexible material.

Alternatively, the thin sheet of flexible material may be combined with other sheets of material to produce a laminate that is substantially rigid. In a preferred embodiment, a laminate of three sheets of material is constructed wherein the two outermost sheets are in tension with respect to the third or inner sheets. This construction imparts a higher degree of rigidity and flatness than is normally achieved with other laminate constructions.

One or both of the outer layers of the laminate thin sheet of material may have three-dimensional surface features (FIG. 4) configured to increase the topographical surface area. One preferred embodiment involves an outer layer of the thin laminate that it suitable for the retention of biomolecules that is modified to exhibit three-dimensional surface features. Another preferred embodiment involves an outer layer that is modified to exhibit three-dimensional surface features and then coated with a layer of a material suitable for retaining biomolecules. Examples of such features are shown as (410, 420, 430). Smaller surface features (440) within larger features (450) are particularly beneficial.

One or more of the layers of the laminate thin sheet of material may have three-dimensional surface features (FIG. 4) configured to increase the topographical surface area A preferred embodiment would be to have these surface features on the outermost surface of the laminate film. A laminate sheet with such surface features on an interior surface of one or more of the thin sheets of material within the laminate would also have additional utility as a means of moving fluids across the surface of one of the sheets or between the surfaces of the sheets.

One or more of the layers of the laminate may have optical properties. In one embodiment, one of the sheets may be opaque to electromagnetic radiation and in particular light. A further embodiment would involve one of the surfaces of the sheets to be black or mirrored.

One or more of layers of the thin laminate sheet of flexible material can be configured to be optically active. A sheet may be able to emit, capture or channel electromagnetic, and in particular, visible radiation emitted from an interaction between coupled biological molecules that may be attached to other layers of the laminate.

One or more of the layers of the thin laminate sheet of flexible material can be configured to have electrical properties. In a preferred embodiment, at least one layer is conductive and can conduct signals to electrodes placed at the edges of the layer. In yet another embodiment, conductive electrical paths form a grid or matrix arrangement in the layer, Interactions between biomolecules and other molecules produce a stimulus that results in an electrical signal in branches of two (or more) electrical pathways within the sheet. A correlation of such separate signals permits the location of an event to be determined. A time related determination of signal strength allows a determination of reaction rate.

In a preferred embodiment of this invention, the thin laminate sheet of flexible material comprises a first sheet of flexible material that has perforations that penetrate from the first surface to the second surface of the sheet. The perforations do not contact each other. The perforations may be disposed on the sheet in a regular pattern. The most beneficial arrangement would require the size and location of the perforation to be identical to the size and spacing of the openings of the wells in a multiwell plate with 96, 384 and 1534 wells. Higher numbers of wells are easily achievable. The invention comprises a lamination of this perforated sheet with a similarly sized sheet that has no perforations. The combination of the two sheets results in a series of well structures where the perforation meets the second sheet. Care must be taken to ensure that there is a sufficient seal at the edge of the perforation. This is to prevent seepage of material from one well to an adjacent well. Individuals skilled in the art of plastic laminations are able to ensure such seals by routine application of existing practices. The capacity of each well is determined by the thickness of the perforated first sheet. Thicker sheets would produce deeper wells with greater volume capacity. The use of multiple perforated sheets laminated with their perforations aligned would also enable deeper wells with more capacity. The non-perforated base can be either flexible or rigid. The sheets can be transparent or opaque.

In a further extension of this invention, the combination of the laminate sheets could be treated by either chemical or physical means to alter the physical characteristics of the surfaces of the wells. In particular, methods to alter the hydrophilic nature of the exposed surface of the well bottom are well known. Plasma treatment is one such option.

In a further extension of this invention, the second, non-perforated sheet could be easily coated with linker materials (such as aminosilanes or epoxysilanes). The linker materials could be a continuous coating or be a series of spots as previously describes. The lamination with the perforated sheet would result in a combination sheet with a plurality of wells each of which has linker material available for the capture of biomolecules.

A further construction involves the use of a porous or fibrous second sheet. The lamination of such a sheet to the first perforated sheet would produce a combination sheet that allows fluid placed into each well site on the combination to pass through the material of the second sheet. In this manner, materials suspended in the fluid would be retained by the second sheet. The flow through fluid can be removed.

A variation on this particular embodiment would involve a laminate construction that uses a first and third perforated sheet sandwiched onto a second porous or fibrous sheet. The sandwich construction would require alignment of the perforations in the first and third sheets. As before the passage of fluid through the exposed areas of the second sheet would receive and retain biomolecules or other suspended materials and permit the evacuation of the fluid. The material received and retained by the second sheet would then be available for further contact with other molecules or biomolecules and other processing.

In all cases, these laminate constructions can be fully flexible or become rigid when thin flexible sheets are laminated with thicker more rigid sheets of material. Since flexibility of sheets can be directly related to the nature of materials used and the thickness of such sheets, it must be recognized that these constructions can be produced with almost any degree of flexibility. All such possibilities are incorporated within this invention.

### Methods of Use

In most embodiments, the flexible nature of the thin sheet of flexible material permits a number of new methods of preparation, processing and analysis. The use of transport mechanisms (FIG. 5) that can move a thin sheet of flexible material (520) from one roller (530) (or similar mechanism) to another can result in more efficient and economic methods of introducing biomolecules to the surfaces. In a preferred embodiment, ink-jet printing methods for ejecting small droplets of a fluid can be used to introduce biomolecules at a thin sheet being passed past the ejection head. In another embodiment, the deposition of electrostatic charge onto a substrate via xerography-like processes would permit localized adherence by biological molecules. The flexibility of the sheet or web is beneficial in the process of moving the thin sheet of material through the printer device. Existing methods of spotting solutions or suspensions of biomolecules will continue to be used on these surfaces. Likewise, the flexible nature of the thin sheet of material will permit more efficient scanning of the sheet by the passage, often via rollers, past a detection system.

The thin sheet of flexible material can be treated or coated with a wide variety of materials that will chemically (or covalently) attach the biomolecules to either the surface or the interior of the thin sheet of flexible material substrate. Some examples of such materials include, but are not limited to, silane moieties, epoxy moieties or aldehyde moieties. Such coatings are generally quite thin and can be deposited by dipping, plasma or vapor phase methods. These methods are well known to practioners of this art. A preferred embodiment involves a web process (FIG. 5) where the flexible sheet (520) is uncoiled from one roller (530), exposed to the coating material wherein it adheres to the exposed surface. After drying and other processes (including the passage of time), the flexible material is recoiled onto another roller or similar mechanism.

Other well known printing methods can introduce the biomolecules to the surface of the thin sheet of flexible material. Various printing methods (including lithographic) are well known as a way of building up complex layers of different inks to produce highly resolved color images. One preferred embodiment of this invention would use a thin sheet of flexible material to receive biomolecules at specific locations defined by markings on an external roller or other embossing device. Passage of the thin sheet of flexible material through successive rollers with biomolecules at distinct (and different) locations would result in a final substrate that comprises biomolecules at a plurality of distinct and discrete sites on the substrate.

Another embodiment of this lithographic or embossing technology would permit the sequential delivery of specific nucleic acids to specific locations on the surface of the thin sheet of flexible material. The first nucleic acid is anchored to known sites on the surface of the flexible sheet. Not every site is populated by the first nucleic acid. A subsequent process applies a different nucleic acid via the lithographic or embossing technology to those sites where the first nucleic acids were deposited and to other sites where no nucleic acids were previously deposited. Where a second nucleic acid is deposited at a site where a first nucleic acid is already present, a stimulus may be required to bond the two molecules into a polymeric sequence. This step-by-step process is repeated until various oligo nucleotides have been assembled at many locations on the thin sheet. This is beneficial since the nature of sequential lithographic printing of material is convenient and accurate.

The thin sheet of flexible material (or plurality of sheets as a laminate), once treated with biomolecules, can be applied to a substrate prior (650) to use as an analytic platform. The combination is sufficient for further preparation, processing and analysis. One preferred embodiment involves attaching by a variety of means, a fragment of a thin sheet of flexible material to a glass microscope slide. Another preferred embodiment would involve placing a small fragment of the thin sheet of flexible material into the well of a multi-well plate.

A first thin sheet of flexible material (or a plurality of sheets as a laminate) may be temporarily attached to a second thin sheet of flexible material surface during the application of the biomolecules. The second sheet is generally larger than the first sheet. This secondary surface is a transfer medium and may be discarded or reused once the first thin sheet (or sheets) of flexible material is peeled or removed. In one beneficial embodiment, the second sheet is a continuous web or ribbon. The first thin sheet of flexible material substrate may then be applied to a final substrate prior to processing or analysis. This final substrate may be rigid, flexible or a continuous ribbon. There may be several intermediate such sheets used during the preparation or processing stages.

A preferred embodiment of this invention involves the use of a thin sheet of flexible material of a size that is compatible with known and accepted microarray or microwell formats. A commonly used microarray format requires a rigid substrate, usually glass, sized to be 1″×3″, One form of the invention would require thin sheet of flexible material sized less that 1″ by 3″ to be affixed to the rigid substrate. Such label-like thin sheet of flexible materials (FIG. 6) would become the active surface of microarray experiments and could easily be accommodated within the framework of existing equipments and protocols. Such label-like thin sheet of flexible materials, when printed with a select number of biomolecules with known relevance to a specific disease or genetic disorder, would find application as a diagnostic tool.

Such label-like thin sheets of flexible material (FIG. 6) would also provide a convenient medium for the storage and transport of biomolecules or biomarkers retained to a surface. A sheet (650) of several such small label-like thin sheets (600, 610,630,) attached to another substrate so as to be removable (640) at some future time. This would also provide a beneficial means of transporting and storing biomolecules for later use.

### Methods of Manufacture

This invention allows the manufacture of thin sheet of flexible material based on a wide range of materials. A preferred embodiment would be based upon polymeric materials such as polyethylene, polypropylene, polystyrene, polyamides or polycarbonates etc. Other materials include metallic films or films of a fibrous nature such as nitrocellulose or cellulosic materials. Generally the thin sheet of flexible material would have a thickness in the range 0.1 microns up to 0.5 centimeters. Thicker sheets might be possible but the rigidity would be increased and most of the benefits of flexibility would be lost. Thin sheet of flexible materials with thicknesses greater than 0.1 micron would generally have sufficient mechanical integrity to be handled without the need for a support substrate. Laminates of several thin sheets of material would be made from sheets of similar or different materials with similar or differing thicknesses. In one embodiment, one of the sheets, usually an outer sheet may comprise material suited to attach the biological molecule to the remaining laminate of sheets of material. In another embodiment, the sheet comprising material suited to attach the biological molecules could become an interior sheet after a protective or sealing layer is added to the layer retaining the biological molecules.

The thin laminate sheet of flexible material will have a sheets comprising material suited for the attachment of biological molecules at its surface or within its interior. In a preferred embodiment, this sheet may have surface features on or in the sheet. These features will increase the topographical surface area available for attachment of biological molecules.

Other methods of producing such thin sheet (or laminate sheet) of flexible material would be based on successive deposition of fibrous materials onto other sheets or a sheet of thin flexible material. Deposition, usually from suspension, results in the creation of a paper-like mat that has interstitial voids. Pre- or post treatment of the individual fibers in the deposited layer to give specific properties beneficial to the preparation, processing, storage or analysis of biomolecules.

The invention can be based on laminates of a variety of materials. A laminate of a least two thin sheet of flexible materials would have several benefits. A first, thin sheet of flexible material would be attached to a second, thin sheet of flexible material or substrates and the composite would become the new thin sheet of flexible material. The process may be repeated until a suitable laminate film is produced. In one embodiment, a first thin sheet of flexible materials could have properties that enhance the performance of a second thin sheet of flexible material. The second sheet of flexible material could, for example, be reflective, absorbing or have greater mechanical strength than the upper substrate.

The thin sheet (or laminate sheet) of flexible material could be manufactured by a variety of methods that include but are not limited to extrusion, molding, peeling, and evaporation.

A thin sheet (or laminate sheet) of flexible material can be manufactured by a variety of methods that include but are not limited to heat bonding, co-extruding, deposition, dipping, and electrolytic plating.

A laminate sheet of material can be subject to a pattern of cuts into its surface. The cut would not penetrate the thickness of the laminate so that the entire construction remains as a single entity. The cuts permit the separation of one part of the laminate sheet by the application of a bending moment along the line of the cut. Such force forces a fracture along the line of the cut. The laminate sheet is now two entities each with a substantially clean edge where the cut previously existed. The pattern of cuts may permit the fragmentation of the initial sheet into a plurality of entities.

A laminate sheet of materials (720) may have printing on one of its surfaces. Such printing will permit identification of the laminate sheet of a fragment of it separated from the initial sheet by a method proposed in the previous paragraph. This may include bar codes (710)

### Novel Applications for the Thin Sheet or Thin Laminate Sheet of Flexible Material

The invention has other applications beyond the analysis and identification of unknown biomolecule. One preferred application allows the attachment of a selection of known biomolecules to the surface of the surface of a thin sheet of flexible material for the purposes of sale, storage and distribution of such known biomolecules. Such sheets might also be attached at a plurality of sites on a larger substrate that can be flexible, rigid or a frame.

The thin sheet of material can be configured in smaller fragments of convenient size that can be attached to another substrate that can be similarly flexible, relatively rigid or a frame. The smaller fragment could contain a selection of biomolecules arranged on the surface of the sheet. The attachment could be completed on a larger substrate containing a plurality of smaller sheets. Such “labels” would be an extremely convenient way of displaying the biomolecules since a smaller sheet can be removed from its supporting substrate and transferred to another substrate for processing and analysis.

The invention is advantageous in that the “label” sheets containing the biomolecules can be easily attached and removed from the substrate.

The invention has specific application in screening for sensitivity to select medicines, drugs or vaccines. Known genetic markers or indicators for select biological functions, called biomarkers, can be attached to the thin sheet and these combined surfaces used as a test for efficacy for a particular dosage or sensitivity. In one embodiment, it would be used to detect the beneficial nature of select vaccines for use with the general population. Individual variations with a general population lead to wide variation in the efficacy of a particular vaccine. This invention would provide an economic solution to this challenge. The invention has specific application in screening for a propensity for s particular disease, sensitivity or genetic defect

The thin sheet or laminate sheet of flexible material can be laid on a substrate that is not flat. The application of topical pressure to the flexible sheet will result in it taking on the shape of the underlying substrate. A particular embodiment would involve the union of a flexible sheet to a multi-well plate. The thin flexible sheet may contain biological molecules at select locations and, after placement on the multi-well plate, these locations would be within one or more of the wells.

In another embodiment, a thin sheet of the material or laminate material configured to contain biological molecules at locations on its surface is laid onto the surface of a disk capable of being rotated about a central axis. Once located on such a surface, the disk could be processed and then analyzed by rotation under a suitable detection head

A laminate of thin flexible sheets of material with differing properties will enable one of the sheets of material to be optically active. Making one or more of the sheets into an optical component leads to more interesting possibilities. Converting one of the sheets into a light-emitting device would permit direct illumination of the biomolecules. Such technology exists in the form of at least OLEDs. Defining the optical properties of at least one of the sheets such that light entering from the biomolecules is channeled to an adjacent detector (i.e. a light pipe or an optical fiber) would also be most beneficial. Additionally converting one of the sheets into material capable of total internal reflection will enable electromagnetic radiation to channel out of the thin laminate sheet.

A laminate of thin flexible sheets of material with differing electrical properties would also have beneficial properties. The ability to determine the magnitude and location of a biomolecule interaction via electronic signal sensed by two or more electrical signals conducted or radiated within a one or more of the sheets.

### DEFINITIONS

Thin sheet: A thin sheet of material may be considered as three-dimensional box where one of the dimensions (usually considered as the height) is reduced to be much smaller that the remaining two dimensions. The two opposing faces of the box become the surfaces of the thin sheet as the thickness is reduced and are substantially parallel to each other.

Smooth: Smoothness may be defined in the distance between the highest point of the surface and the lowest. Generally, smooth surfaces have distances defined in this way of less than 0.1 micron. Smoothness may also be recognized in terms of image quality when light is reflected from a smooth surface. Reflection from a non-smooth surface leads to a highly degraded image.

Biomarker: A biological molecule that has characteristics that enables it to signal or indicate that a condition exists on or in another molecule. A section of an individual's genome can dictate their individual propensity to a specific disease or their tolerance to a specific drug or pathogen. A biomarker gives a relative measure of this propensity.

Biomolecule: A biomolecule can be one of several different classes of molecules or moieties found in humans, animals or plants. A small fragment or DNA or RNA would an example. Similarly a complete cell would likewise be considered a biomolecule. Other notable examples include, proteins, antigens, viruses, phages or prions.

Substantially Flat: A rigid surface that is smooth is substantially flat. A flexible surface, however, can be smooth and yet not flat by virtue of the ability of the thin sheet to be bent in a variety of directions.

Surface: A surface is generally defined as a series of points where two distinct materials meet.

Flexible surface: A flexible surface is defined in terms of a radius of curvature (FIG. 8); when a point on surface is bent such that one face containing the point is moved towards contact with the same face at some distant point, the compound surface may be described in terms of a series of arcs with differing radii of curvature.

Porous: A porous material comprises a first material that has a series of cavities comprising a second material within the body of the first material. Typically, but not necessarily, the second material cavities are interconnected. In the case where the second material is a fluid, and in particular, a gas, then other moieties can move through these cavities. Generally, the distribution of such cavities is uniform in any direction within the body of the first material. Generally a passage way from one cavity leads to another cavity and so on.

Anisotropic, branched: Anisotropic, branched surface features are formed at the interface of a first material and a second material. Such surface features proceed into the interior of the body of the second material. Surface features associated with the second material extend substantially on one direction and divide periodically into smaller features as they progress deeper into the body of the first material

Rigid: A rigid body cannot be easily distorted (i.e. bent, twisted, compressed or stretched. Rigid materials often break or fracture when subjected to such motions. Substantially rigid materials can withstand slight motions of this kind.

Retained: A biomolecule is retained onto or within a surface (or in near proximity to the actual interface between the two materials comprising the surface) when it cannot move substantially with respect to points within the plane of the sheet.

Anchored: Biomolecules that are anchored to a surface (or in near proximity to the actual interface between the two materials comprising the surface) are restrained from movement by a specific means such as covalent bonding between molecules in the surface and the biomolecule.

Linker Material: Certain molecules are used to anchor biomolecules to surfaces by attaching one end to the surface and the other end to the biomolecule. The linkage is often covalent in nature. Such materials include but are not limited to aminosilanes and epoxysilanes.

High Volume, Web Processing for Surface Modification: Thin sheets in rolls ranging in width from 1 inch to 10 meters, in length from 1 meter to 100,000 meter, and in thickness from 5 micrometers to 0.001 meters are modified by rolling the sheet off a cylindrical shaped storage roller onto another cylindrical shaped roller where it's surface is modified as it rolls before rolling onto another cylindrical shape roller. Surfaces can be modified using a variety of methods (such as, but not limited to, sputtered coatings, vapor deposition, chemical vapor deposition, physical vapor deposition, cathodic arc, thermal evaporation, electron beam, and plasma) in either atmospheric or vacuum environments. The sheets are typically processed at a rate of 0.01 meter per_second to 10 meters/second A lower rate might be required for certain processes. The process may be repeated.

### BRIEF DESCRIPTION OF THE DRAWINGS

FIG. 1: A Thin Sheet of Flexible Material

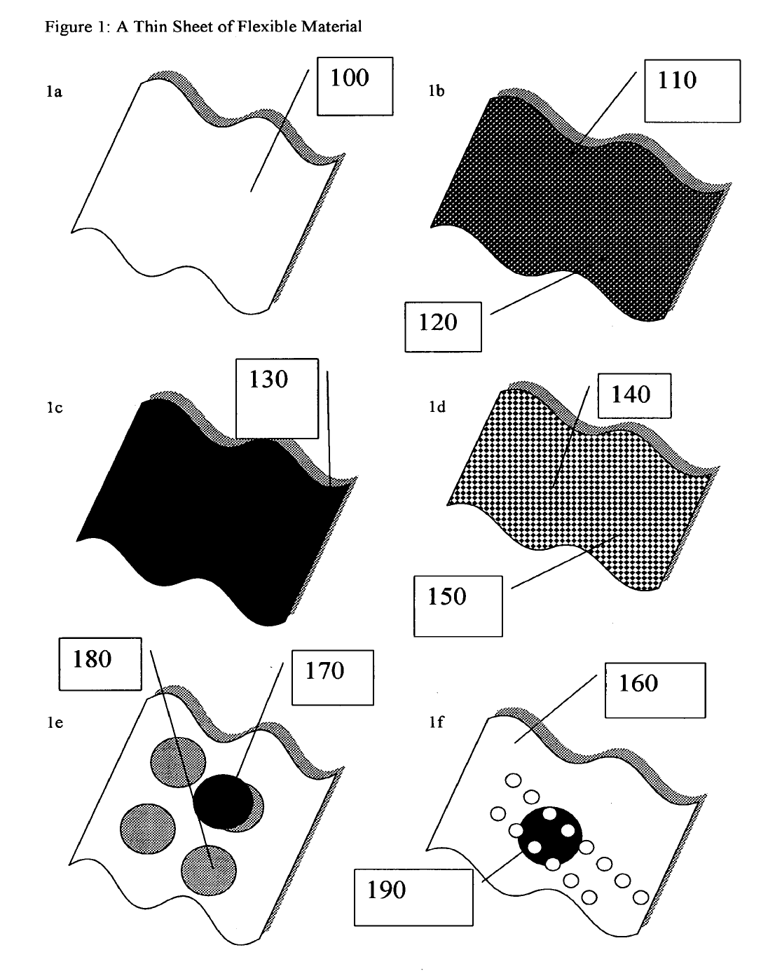

FIG. 2: A Thin Sheet of Flexible Material with Three-Dimensional Surface Features

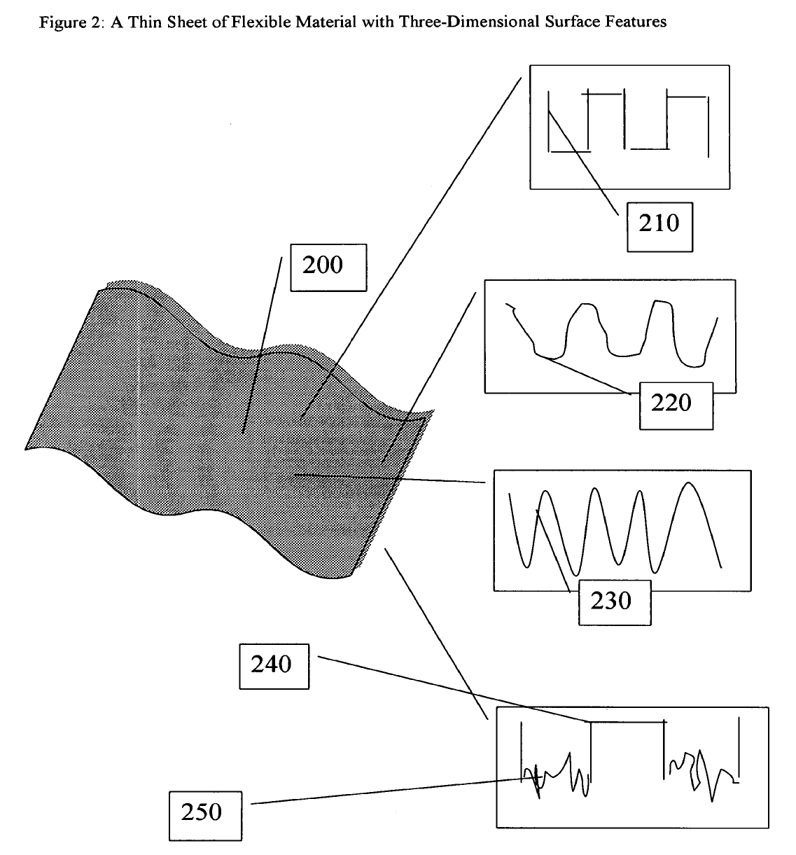

FIG. 3: A Thin Laminate Sheet of Flexible Material.

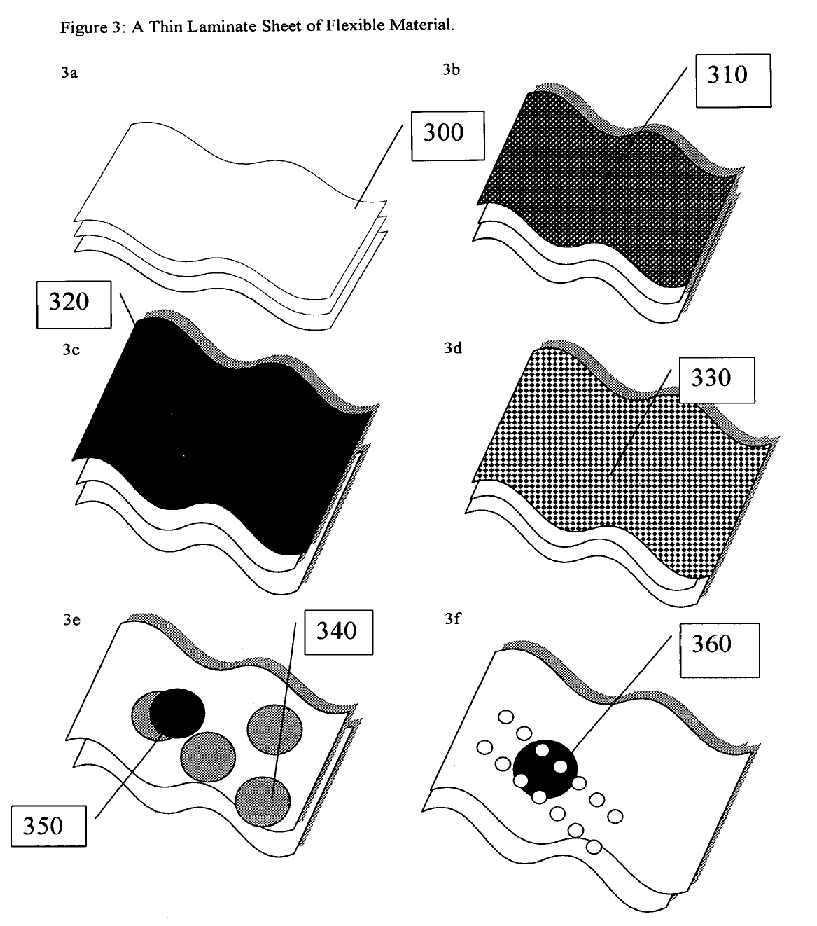

FIG. 4: A Thin Laminate Sheet of Flexible Material with Three-Dimensional Surface Features

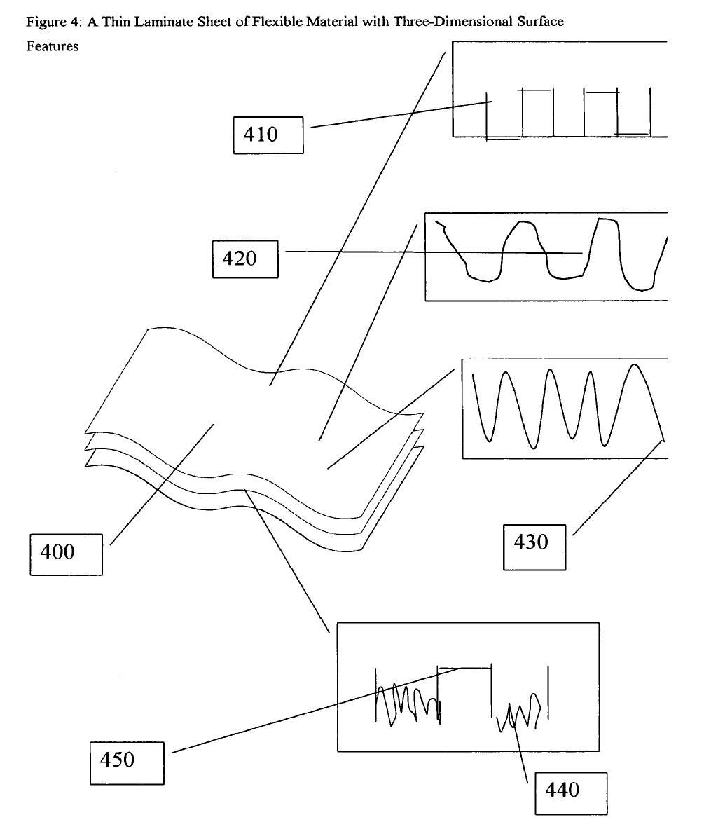

FIG. 5: A Thin Sheet of Flexible Material (including Laminate) in the Form of a Web, a Ribbon or a Fragment (either Flexible or Rigid)

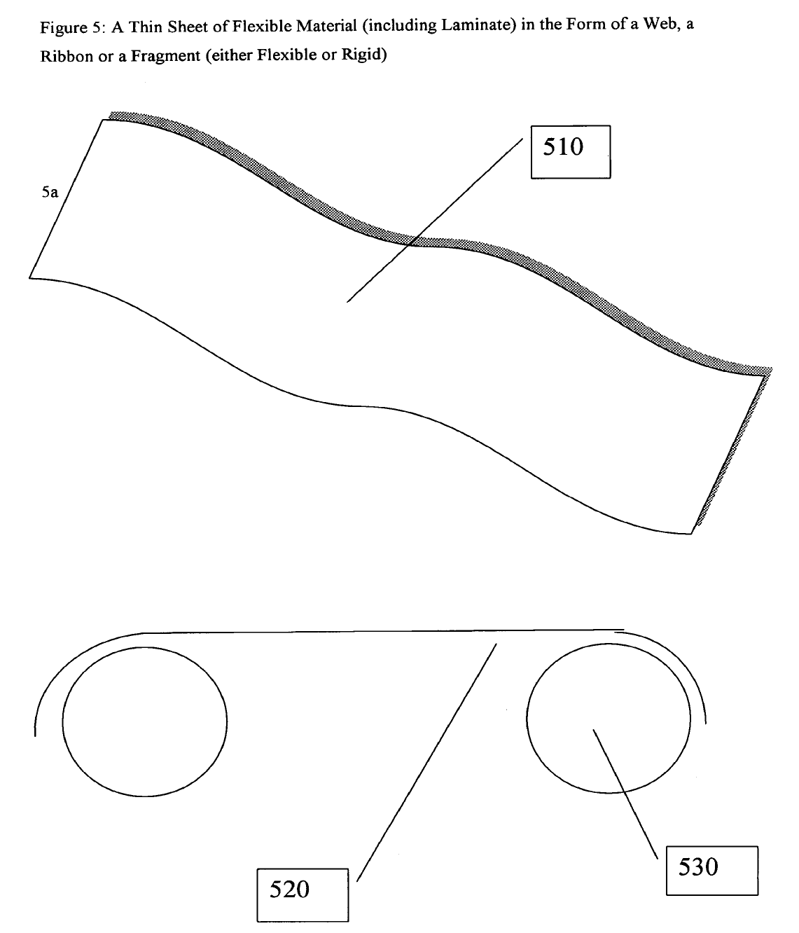

FIG. 6: A Thin sheet of Flexible Material (including Laminate) Reversibly Attached to Another Substrate.

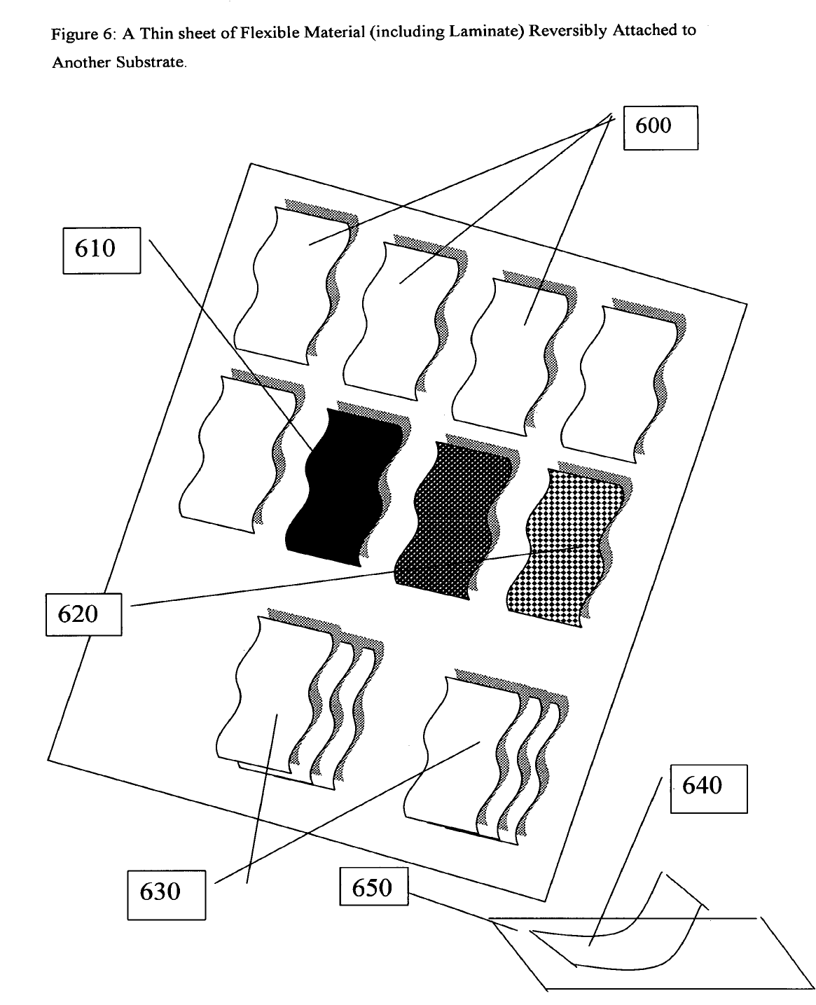

FIG. 7: A Thin Sheet of Flexible Material (including Laminate) with Surface Identification and Location Markings

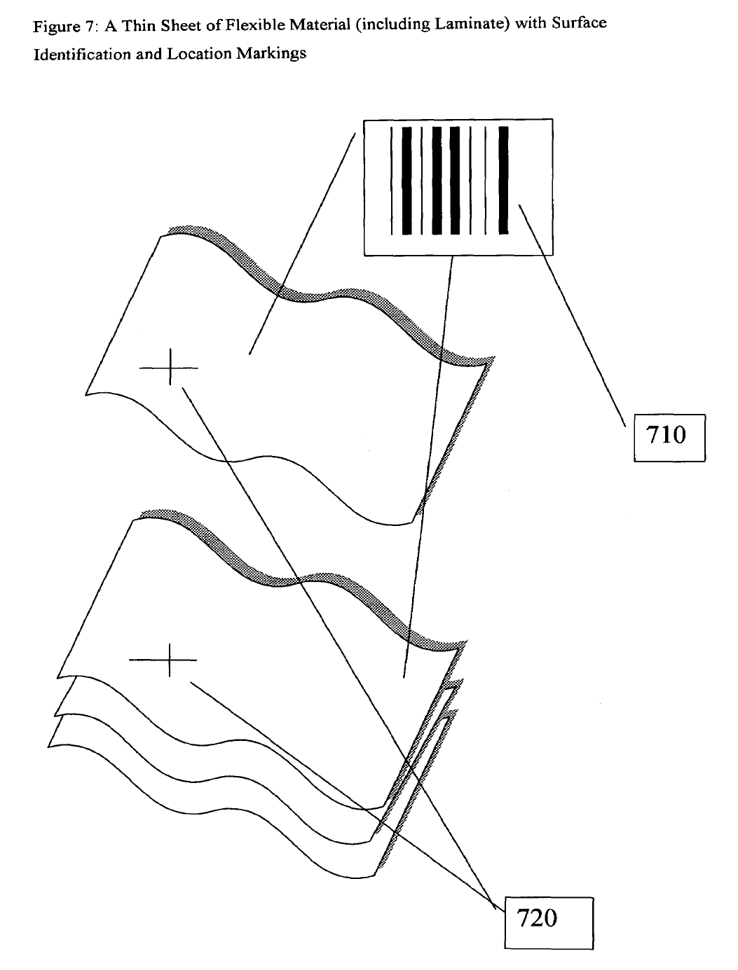

FIG. 8: Definition of Radii of Curvature for a Flexible Surface

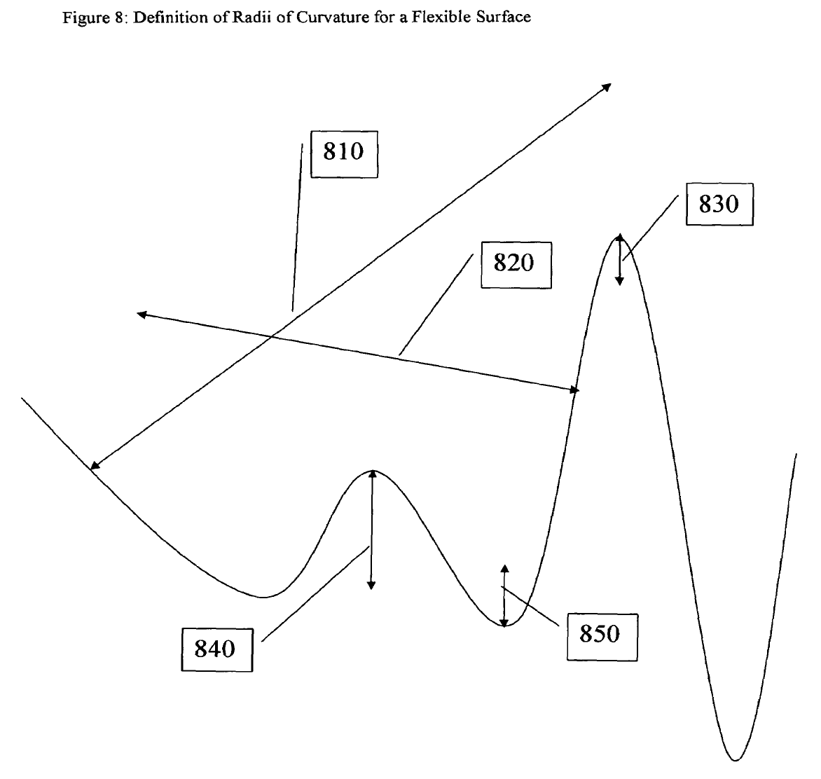

1. A support for biological molecules comprising at least a portion of a surface of a thin sheet configured at a plurality of distinct locations to receive and retain biological molecules wherein at least two adjacent distinct locations are required to retain said biological molecules and wherein biological molecules of different compositions are received and retained by at least two other adjacent distinct locations.

2. A support of claim 1 wherein the thin sheet is comprised of a polymeric, metallic, ceramic material or a combination.

3. A support of claim 1 wherein the distinct locations on the thin sheet comprise a linker material, different from the material of the said substrate, that is able to adhere to said substrate and also retain biological molecules.

4. A support of claim 3 wherein the linker material comprise a molecule with two distinct sites one of which is able to covalently bond to the material of the thin sheet while the other site able to covalently link with a biological molecule

5. A support of claim 1 wherein the distinct locations on the thin sheet have different physical properties than the remainder of the thin sheet wherein these physical properties are able to retain biological molecules to a portion of said substrate.

6. A support of claim 1 wherein at least two distinct locations are spots of linker material and these spots are able to bind a single spot of biological molecules placed onto the at least two distinct locations.

7. A support of claim 1 wherein either of both surfaces of the flexible material can receive markings that provide unique identification.

8. A support of claim 1 wherein the thin sheet is configured as a narrow ribbon that can be moved relative to a deposition or detection system

9. A support for biological molecules comprising at least a portion of a surface of a thin sheet comprising at least two thin sheets wherein said surface is configured at a plurality of distinct locations to receive and retain biological molecules wherein biological molecules of different compositions are received and retained at said locations.

10. A support of claim 9 wherein any thin sheet is comprised of a polymeric, metallic, ceramic material or a combination.

11. A support of claim 9 wherein the distinct locations on the thin sheet comprise a linker material, different from the material of the said substrate, that is able to adhere to said substrate and also retain biological molecules.

12. A support of claim 9 wherein the linker material comprise a molecule with two distinct sites one of which is able to covalently bond to the material of the thin sheet while the other site able to covalently link with a biological molecule

13. A support of claim 9 wherein the distinct locations on the thin sheet have different physical properties than the remainder of the thin sheet wherein these physical properties are able to retain biological molecules to a portion of said substrate.

14. A support of claim 9 wherein at least two distinct locations are spots of linker material and these spots are able to bind a single spot of biological molecules placed onto the at least two distinct locations.

15. A support of claim 9 wherein either of both surfaces of the flexible material can receive markings that provides unique identification.

16. A support of claim 9 wherein the thin sheet is configured as a narrow ribbon that can be moved relative to a deposition or detection system

17. A support of claim 9 wherein at least a portion of an outer surface of the flexible laminate substrate is conformally coated with a material that is able to receive and retain biological molecules.

18. A support for biological molecules comprising at least a portion of a surface of a thin sheet wherein at least a portion of said surface comprises microfeatures configured to receive and retain biological molecules wherein at least two adjacent distinct microfeatures are required to retain said biological molecules and wherein biological molecules of different compositions are received and retained by at least two other adjacent distinct microfeatures.

19. A support of claim 18 wherein at least a portion of an outer surface of the flexible laminate substrate is conformally coated with a material that is able to receive and retain biological molecules.

20. A support of claim 18 wherein any thin sheet is comprised of a polymeric, metallic, ceramic material or a combination.

21. A support of claim 18 wherein the microfeatures are comprised of materials different from any of the materials of the thin sheet.

22. A support of claim 18 wherein the microfeatures disposed on at least a portion of the thin sheet comprise pits, trenches, pillars, cones, rods, tubes, particles or a combination thereof.

23. A support of claim 18 wherein the microfeatures increase the surface area of at least one surface of the thin sheet by at least 20% compared to a similar sheet with at least one surface that is smooth and flat.

24. A support of claim 18 wherein a surface of the thin sheet can be marked to provide a unique means of identification.

25. A support for biological molecules comprising a first sheet of flexible material that has a plurality of perforations that penetrate said first sheet from one surface to the opposing surface wherein said first sheet is coupled to a second sheet having substantially no perforations so as to produce a plurality of wells on the first surface of the combination wherein the surface of said wells are configured to receive and retain biomolecules.

26. A support of claim 25 wherein those portions of the second sheet that are exposed by the perforations of sheet 1 comprise microfeatures and a material for receiving and retaining biological molecules.

27. A support of claim 25 wherein a surface of the second sheet is coated with a linker material configured to receive and retain biological molecules wherein the coated surface is in contact with one of the surfaces of the first sheet

28. A support of claim 25 wherein the surfaces of combination of first and second sheets are subject to chemical or physical processes that alter the surface characteristics of the portions of the second sheet that are exposed by the perforations in the first sheet

29. A support of claim 25 wherein the first sheet of flexible material comprises a combination of at least two distinct sheets of flexible material.

30. A support for biological molecules comprising a combination of at least a portion of thin sheet material with substantially rigid substrate material wherein a surface of the flexible material is configured to receive and retain biological molecule.

31. A support for biological molecules of claim 30 comprising a combination of at least three sheets of flexible material wherein the two outermost sheets are in tension with respect to the middle sheet and wherein one surface of either of the outermost sheets is configured to allow biological molecules of one composition be received and retained at a location and biological molecules of other compositions are received and retained at other distinct locations.

32. A support for biological molecules comprising a combination of at least a portion of thin sheet material with a surface configured to receive and retain biological molecules with substantially rigid substrate material wherein at least one surface of said rigid substrate has microfeatures wherein the thin sheet conforms to the microfeature.
